(19) United States
(12) Patent Application Publication
(10) Pub. No.: US 2023/0245050 A1
(43) Pub. Date: Aug. 3, 2023

(54) METHODS AND APPARATUSES FOR DETERMINING STORE SEGMENTATION AND STORE SPACE ALLOCATION

(71) Applicant: Walmart Apollo, LLC, Bentonville, AR (US)

(72) Inventors: Akshay Singhal, Bentonville, AR (US); Ajinkya Ajay More, Santa Clara, CA (US)

(21) Appl. No.: 17/587,224

(22) Filed: Jan. 28, 2022

(51) Int. Cl. G06Q 10/08

(52) U.S. Cl. CPC G06Q 10/087

(57) ABSTRACT

A system for determining store segments and store space allocation may include at least one computing device that is configured to obtain store sales data for each store in a group of stores and to determine a store segmentation score using a non-Euclidean distance metric characterizing a distance between a pair of stores in the group of stores. The computing device may also be configured to assign each store to a store segment based on the store segmentation score and validate a divergence of each pair of store segments using a divergence score metric.

### TECHNICAL FIELD

The disclosure relates generally to methods and apparatuses for determining store segmentation and store space allocation.

### BACKGROUND

At least some organizations, such as retail organizations, determine store space allocation. The store space allocation describes the amount or layout of space within a retail store that will be used to provide various types of products. The store space allocation, for example, may describe an amount or portion of the store that will be used for each product department, for each product category or for other separable divisions of products or services sold or provided in the store. The store space allocation is determined with the intention to allocate store space in a manner to achieve business objectives such as to maximize sales, maximize profits, maximize customer satisfaction and/or minimize costs.

The allocation of store space is performed at an initial stage of store operation and then again on a periodic basis. The effort required to re-allocate store space can be a resource intensive endeavor so the re-allocation process may only be performed on a seasonal or annual basis. Because the allocation or re-allocation process requires significant resources, organizations place increased importance on a proper or efficient store space allocation to achieve its business objectives.

The process of determining an optimized store space allocation is a complex task. The task can be particularly complex and difficult when an organization must make the allocation task for hundreds or thousands of store locations. Existing apparatuses and methods of determining store allocations suffer from various problems or drawbacks. For example, existing apparatuses and methods often determine store allocations without consideration of differing customer behavior, customer demand and other customer characteristics between store locations. In addition, existing methods may require significant time and other resources to accomplish. Still further existing apparatuses and methods may recommend that stores include different store allocations or common store allocations that do not significantly impact the business objectives of the organizations. Thus, existing apparatuses and methods may lead to non-value-added expenditures or to inefficient use of resources for the organizations. There exists a need, therefore, for improved apparatuses and methods for determining store allocations that efficiently use an organization's resources to achieve its business objectives.

### SUMMARY

The embodiments described herein are directed to apparatuses and methods for determining store space allocations and/or store segments. The store space allocation and/or store segments can be used to prepare store layouts that can be used to drive business objectives such as improved revenue, sales, profits, customer satisfaction and the like. The apparatuses and methods of the present disclosure can determine divergent store segments that can identify different groupings of store that share common purchasing patterns, customer behavior or other similar characteristics. The store segments can be determined using machine learning models or other suitable algorithms that may employ a non-Euclidean distance metric. The divergence of the store segments can be validated and then used to prepare store space allocations for each grouping or segment of stores.

In accordance with various embodiments, exemplary systems may be implemented in any suitable hardware or hardware and software, such as in any suitable computing device. For example, in some embodiments, a computing device is configured to obtain store sales data for each store in a group of stores and determine a store segmentation score using a non-Euclidean distance metric. The non-Euclidean distance metric may characterize a distance between pairs of stores in the group of stores. The computing device may also be configured to assign each store to a store segment based on the store segmentation score and validate a divergence between store segments using a divergence score metric.

In one aspect, the store sales data may include historical sales data for a plurality of categories of products, and the store segmentation score may be determined using a sub-set of categories from the plurality of categories of products. The sub-set of categories may include sales of products in categories for a predetermined percentage of overall sales of all products in the plurality of categories.

In another aspect, each store may be assigned to a store segment using a machine learning model.

In another aspect, the machine learning model may include a Gaussian Mixture Model (GMM).

In another aspect, the non-Euclidean distance metric may be an Aitchison distance metric.

In another aspect, the divergence score metric may be a Jensen-Shannon divergence metric.

In another aspect, the computing device may be further configured to determine store space allocations for each store segment.

In some embodiments of present disclosure, a method for determining store segments is provided. The method may include obtaining store sales data for each store in a group of stores and determining a store segmentation score using a non-Euclidean distance metric. The non-Euclidean distance metric may characterize a distance between a pair of stores in the group of stores. The method may also include assigning each store to a store segment based on the store segmentation score and validating a divergence of pairs of store segments using a divergence score metric.

In some embodiments, a non-transitory computer readable medium is provided. The non-transitory computer readable medium may have instructions stored thereon, wherein the instructions, when executed by at least one processor, cause a device to perform operations that include obtaining store sales data for each store in a group of stores and determining a store segmentation score using a non-Euclidean distance metric. The non-Euclidean distance metric may characterize a distance between a pair of stores in the group of stores. The operations may also include assigning each store to a store segment based on the store segmentation score and validating a divergence of each store segment using a divergence score metric.

### BRIEF DESCRIPTION OF THE DRAWINGS

The features and advantages of the present disclosures will be more fully disclosed in, or rendered obvious by the following detailed descriptions of example embodiments. The detailed descriptions of the example embodiments are to be considered together with the accompanying drawings wherein like numbers refer to like parts and further wherein:

FIG. 1 is a block diagram of a store space allocation system in accordance with some embodiments;

FIG. 2 is a block diagram of an example store segmentation computing device in accordance with some embodiments;

FIG. 3 is a block diagram of aspects of the store space allocation system of FIG. 1 in accordance with some embodiments; and

FIG. 4 is a graph illustrating product category sales percentages for an example store segmentation using an existing methodology as compared to national average product category sales percentages;

FIG. 5 is a graph illustrating product category sales percentages for a store segmentation using the apparatuses and methods of the present disclosure as compared to a national average product category sales percentages; and

FIG. 6 is a flow chart illustrating an example method of determining store segments in accordance with some embodiments.

### DETAILED DESCRIPTION

The description of the preferred embodiments is intended to be read in connection with the accompanying drawings, which are to be considered part of the entire written description of these disclosures. While the present disclosure is susceptible to various modifications and alternative forms, specific embodiments are shown by way of example in the drawings and will be described in detail herein. The objectives and advantages of the claimed subject matter will become more apparent from the following detailed description of these exemplary embodiments in connection with the accompanying drawings.

It should be understood, however, that the present disclosure is not intended to be limited to the particular forms disclosed. Rather, the present disclosure covers all modifications, equivalents, and alternatives that fall within the spirit and scope of these exemplary embodiments. The terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship.

As further explained below, the present disclosure is directed to apparatuses and methods for determining store segmentation that can be used to prepare store space allocations. The store segmentations can be used so that store space allocations can be prepared for each store segment. The store segments can be created to group stores that include similar buying patterns, in which customers exhibit similar purchasing behavior and the like. Existing or traditional systems and methods often include making store space allocation decisions based on trends from an enterprise level. In such systems and methods, an average of all stores may be used to make store space allocations or other decisions. Such a practice does not allow the organization to optimize is business goals such as maximizing sales, maximizing profit, or maximizing customer satisfaction.

Some organizations may have hundreds or thousands of stores. When enterprise-level averages or national trends are used to make decisions, individual differences between stores can be diluted and/or lost. For the foregoing reasons, organizations may desire to make decisions based on the specific customer behaviors, customer preferences and/or sales patterns of individual stores. Managing different store allocations for each store location can be costly and resource intensive such that the cost of having different store allocations for each store location is cost prohibitive. Organizations, therefore, may desire to group stores into store segments wherein each segment shares common or similar sales patterns, customer behavior, purchasing patterns and the like so that sales allocations can be made and implemented for each store segment. This type of implementation is more manageable and resource efficient than individual store allocations while still taking differences among stores into consideration.

The apparatuses and methods of present disclosure provide improvement over existing and traditional methods. The apparatuses and methods of the present disclosure provide store segments that exhibit verifiable differences between the store segments. The store segments demonstrate divergence measures greater than those provided by traditional methods. The application of the store segments of the present disclosure can better account for the differences in customer behavior and purchasing patterns between stores so that store allocations can be determined that optimize the organization's business objectives.

The description below describes the use and implementation of the apparatuses and methods of the present disclosure in the context of a large scale retailer of consumer products. It should be appreciated, however, that aspects and examples of the present disclosure can be used in other contexts, industries and environments as well.

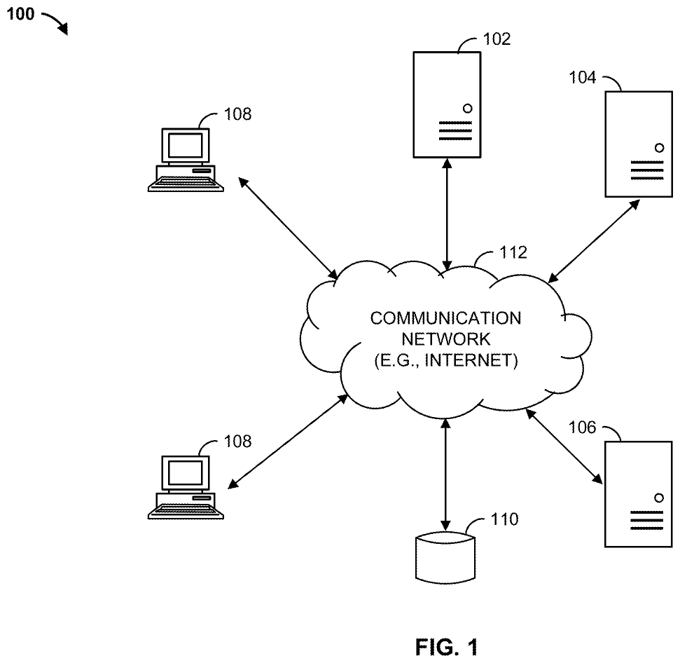

Turning to the drawings, FIG. 1 illustrates a block diagram of a store space allocation system 100 that includes a store segmentation computing device 102 (e.g., a server, such as an application server), a sales server 104 (e.g., a server, such as an application or web server), a product information server 106, workstation(s) 108, and database 110 operatively coupled over network 112. store segmentation computing device 102, sales server 104, product information server 106, and workstation(s) 108 can each be any suitable computing device that includes any hardware or hardware and software combination for processing and handling information. For example, each can include one or more processors, one or more field-programmable gate arrays (FPGAs), one or more application-specific integrated circuits (ASICs), one or more state machines, digital circuitry, or any other suitable circuitry. In addition, each can transmit data to, and receive data from, communication network 112.

In some examples, store segmentation computing device 102 can be a computer, a workstation, a laptop, a server such as a cloud-based server, or any other suitable device. In some examples, each of workstations 108 can be desktop computer, a cellular phone, a smart phone, a tablet, a personal assistant device, a voice assistant device, a digital assistant, a laptop, a computer, or any other suitable device. In some examples, store segmentation computing device 102 is operated by a retailer, and multiple workstations 108 are operated by merchants, buyers or other operators that have a role in the ordering, buying, configuration and stocking of retail stores.

The store segmentation computing device 102 is operable to communicate with database 110 over communication network 112. For example, store segmentation computing device 102 can store data to, and read data from, database 110. Database 110 can be a remote storage device, such as a cloud-based server, a memory device on another application server, a networked computer, or any other suitable remote storage. Although shown remote to store segmentation computing device 102, in some examples, database 110 can be a local storage device, such as a hard drive, a non-volatile memory, or a USB stick.

Communication network 112 can be a WiFi® network, a cellular network such as a 3GPP® network, a Bluetooth® network, a satellite network, a wireless local area network (LAN), a network utilizing radio-frequency (RF) communication protocols, a Near Field Communication (NFC) network, a wireless Metropolitan Area Network (MAN) connecting multiple wireless LANs, a wide area network (WAN), or any other suitable network. Communication network 112 can provide access to, for example, the Internet.

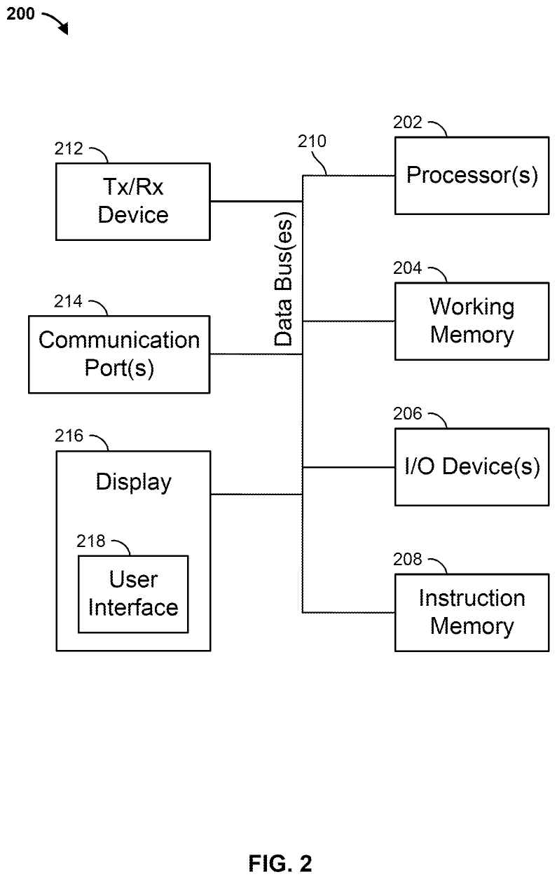

FIG. 2 illustrates an example computing device 200. The store segmentation computing device 102, the sales server 104, the product information server 106, and/or the workstation(s) 108 may include the features shown in FIG. 2. For the sake of brevity, FIG. 2 is described relative to the store segmentation computing device 102. It should be appreciated, however, that the elements described can be included, as applicable, in the sales server 104, the product information server 106, the workstation(s) 108 and/or other computing devices that are part of the store space allocation system 100 or that may work in connection with the store space allocation system 100.

As shown, the store segmentation computing device 102 can be a computing device 200 that may include one or more processors 202, working memory 204, one or more input/output devices 206, instruction memory 208, a transceiver 212, one or more communication ports 214, and a display 216, all operatively coupled to one or more data buses 210. Data buses 210 allow for communication among the various devices. Data buses 210 can include wired, or wireless, communication channels.

Processors 202 can include one or more distinct processors, each having one or more cores. Each of the distinct processors can have the same or different structure. Processors 202 can include one or more central processing units (CPUs), one or more graphics processing units (GPUs), application specific integrated circuits (ASICs), digital signal processors (DSPs), and the like.

Processors 202 can be configured to perform a certain function or operation by executing code, stored on instruction memory 208, embodying the function or operation. For example, processors 202 can be configured to perform one or more of any function, method, or operation disclosed herein.

Instruction memory 208 can store instructions that can be accessed (e.g., read) and executed by processors 202. For example, instruction memory 208 can be a non-transitory, computer-readable storage medium such as a read-only memory (ROM), an electrically erasable programmable read-only memory (EEPROM), flash memory, a removable disk, CD-ROM, any non-volatile memory, or any other suitable memory.

Processors 202 can store data to, and read data from, working memory 204. For example, processors 202 can store a working set of instructions to working memory 204, such as instructions loaded from instruction memory 208. Processors 202 can also use working memory 204 to store dynamic data created during the operation of store segmentation computing device 102. Working memory 204 can be a random access memory (RAM) such as a static random access memory (SRAM) or dynamic random access memory (DRAM), or any other suitable memory.

Input-output devices 206 can include any suitable device that allows for data input or output. For example, input-output devices 206 can include one or more of a keyboard, a touchpad, a mouse, a stylus, a touchscreen, a physical button, a speaker, a microphone, or any other suitable input or output device.

Communication port(s) 214 can include, for example, a serial port such as a universal asynchronous receiver/transmitter (UART) connection, a Universal Serial Bus (USB) connection, or any other suitable communication port or connection. In some examples, communication port(s) 214 allows for the programming of executable instructions in instruction memory 208. In some examples, communication port(s) 214 allow for the transfer (e.g., uploading or downloading) of data, such as store sales data, product information data, historical data, and the like.

Display 216 can display a user interface 218. User interfaces 218 can enable user interaction with the store segmentation computing device 102. For example, user interface 218 can be a user interface that allows an operator to interact, communicate, control and/or modify different messages, settings, or features that may be presented or otherwise displayed to a user by a network-enabled tool such as workstation 108. The user interface 218 can include a slider bar, dialogue box, or other input field that allows the user to control, communicate or modify a setting, limitation or input that is used in the determination of store segments or store space allocations. In addition, the user interface 218 can include one or more input fields or controls that allow a user to modify or control optional features or customizable aspects of the store segmentation computing device and/or the store segments and store space allocations. In some examples, a user can interact with user interface 218 by engaging input-output devices 206. In some examples, display 216 can be a touchscreen, where user interface 218 is displayed on the touchscreen. In other examples, display 216 can be a computer display that can be interacted with using a mouse or keyboard.

Transceiver 212 allows for communication with a network, such as the communication network 112 of FIG. 1. For example, if communication network 112 of FIG. 1 is a cellular network, transceiver 212 is configured to allow communications with the cellular network. In some examples, transceiver 212 is selected based on the type of communication network 112 store segmentation computing device 102 will be operating in. Processor(s) 202 is operable to receive data from, or send data to, a network, such as communication network 112 of FIG. 1, via transceiver 212.

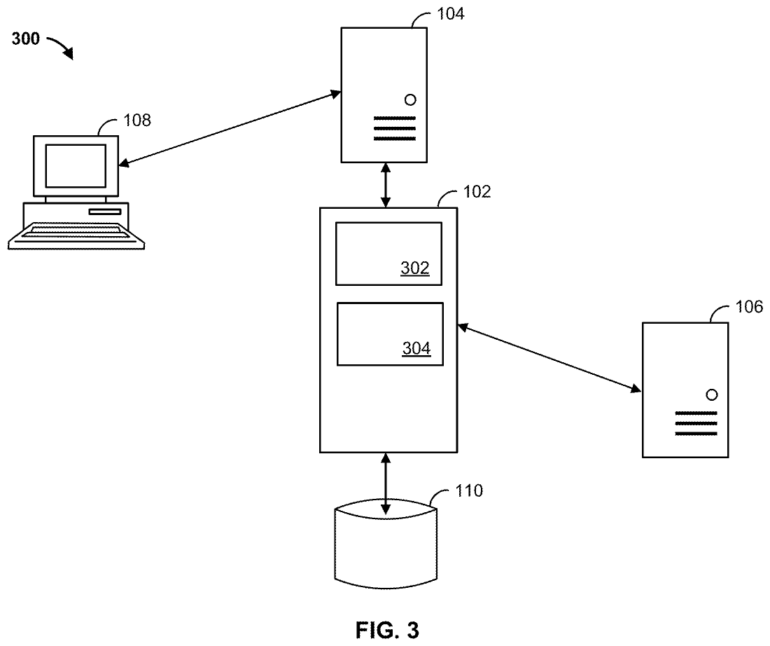

Turning now to FIG. 3, another example store space allocation system 300 is shown. The store space allocation system 300 can be similar to the store space allocation system 100 previously described. While not shown, the various elements of the store space allocation system 300 can be connected via a communication network such as network 112. In other examples, one or more of the elements of the store space allocation system 300 can alternatively be connected via wired or local connections.

As shown, the store space allocation system 300 includes store segmentation computing device 102, sales server 104, product information server 106, workstation 108 and database 110. Each of the store segmentation computing device 102, sales server 104, product information server 106, workstation 108 and database 110 can be connected to each to share data and/or information via a suitable communication network. The workstation 108 can be operated by a user that has a need to obtain store segmentation information and/or store space allocation information. Such a user can be a merchant, buyer, or other user that has a role in the process of configuring store layouts and/or for ordering or supplying products to the stores. The user can obtain store segment information and/or store space allocation information from the store segmentation computing device 102. The store segment information and/or the store space allocation information can be provided through a webpage, dashboard or other suitable tool or interface to allow the user to request such information and to display, publish or otherwise provide such information.

The store segmentation computing device 102 can include one or more modules, engines and/or services that can perform various aspects of the methods of the present disclosure. In the example shown, the store segmentation computing device 102 includes a segmentation engine 302 and an allocation engine 304. The segmentation engine 302 can operate to obtain and/or deliver information and data from the store segmentation computing device 102 to the various other elements of the store space allocation system 300. The segmentation engine 302 can include, for example, various application protocol interfaces (APIs) that can allow the store segmentation computing device 102 to retrieve information from the sales server 104, the product information server 106, and/or from the database 110. The segmentation engine 302 can allow the store segmentation computing device to retrieve information from other data sources, computing devices and/or databases that may not be shown. The segmentation engine 302 can also allow the store segmentation computing device 102 to share or deliver information to the other elements of the store space allocation system 300. In some examples, the segmentation engine 302 can also operate to perform transformations or otherwise modify the data before the data is used by the store segmentation computing device 102 or is delivered to another element of the store space allocation system 300. The store segmentation engine 302 can aggregate data, normalize data, truncate data, and/or gap fill the data, for example.

The store segmentation engine 302 can also operate to determine store segments. The store segments can be used, for example, to define multiple groups of stores that include similar purchasing patterns, customer behavior and the like. The store segments allow the efficient deployment of multiple different store space allocations that take advantage of the similar purchasing patterns and/or customer behavior to drive achievement of business objectives. The deployment of different store space allocations for each store segment rather than a common store space allocation for every store can increase the organization's revenue, profits and customer satisfaction. In addition, the store segmentation engine 302 can determine store segments using a non-Euclidean distance metric. The store segments determined using the non-Euclidean distance metric show improved divergence over other methods of segmenting groups of stores.

In the context of the present disclosure, the term divergence is used to describe measurable differences between stores or between groups of stores for a particular characteristic. For example, a characteristic such as sales of a particular product category can be used to determine divergence between stores or a group of stores. In some traditional methods of grouping stores into store segments, a geographical location can be used. Stores can be grouped based on a proximity to a major city or to a distribution center, for example. The average sales penetration can be determined for each sub-category of a product category. These numbers can be compared to one another and to a national sales average. The difference between these numbers can be used to measure the divergence of the store groups, that is, the difference in store sales between each cluster or store segment and the difference between each cluster or group and the national average.

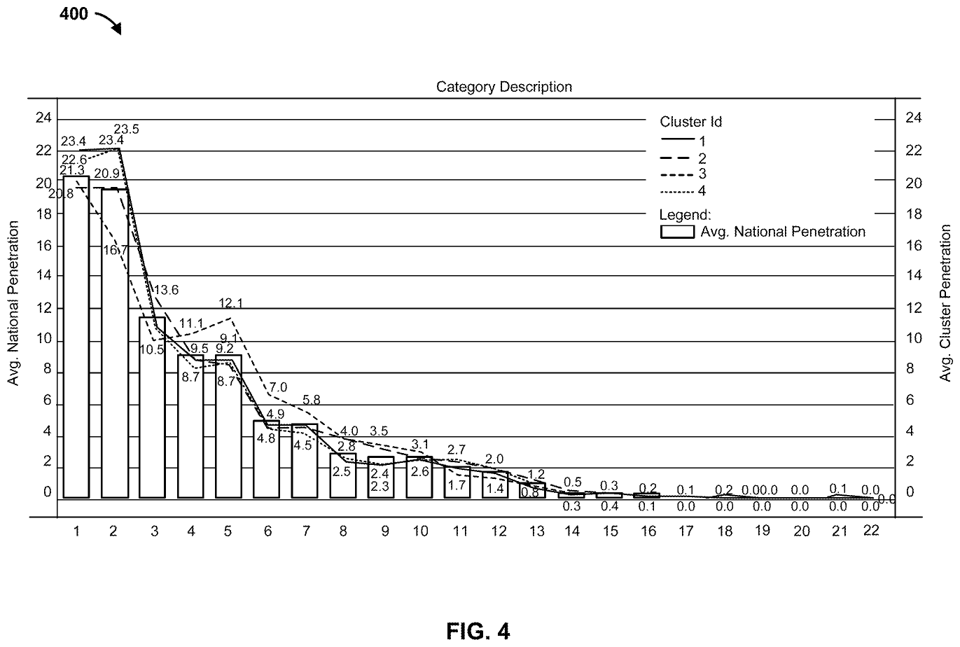

An example of a measure of divergence is shown in FIG. 4. The graph 400 illustrates sales penetration for each sub-category (1, 2, 3, 4 . . . 22) for a category of products. In the example shown, womens' apparel was used. Each of the sub-categories represents the percentage of sales for each sub-category (e.g., active wear, outerwear, tops, bottoms, etc.). This calculation is determined for each cluster and is represented by each line on graph 400. The national sales average for each sub-category was also determined and is represented by the vertical bars for each sub-category. For sub-category 1, the graph 400 shows a national sales penetration average of about 22% with store cluster 1 having a sales penetration of about 23.4%, store cluster 2 having a sales penetration of about 20.8%, store cluster 3 having a sales penetration of about 21.3% and store cluster 4 having a sales penetration of about 22.6%. As can be seen, the sales penetration for each sub-category appears to closely follow the national average and the variation between each cluster is does not vary significantly.

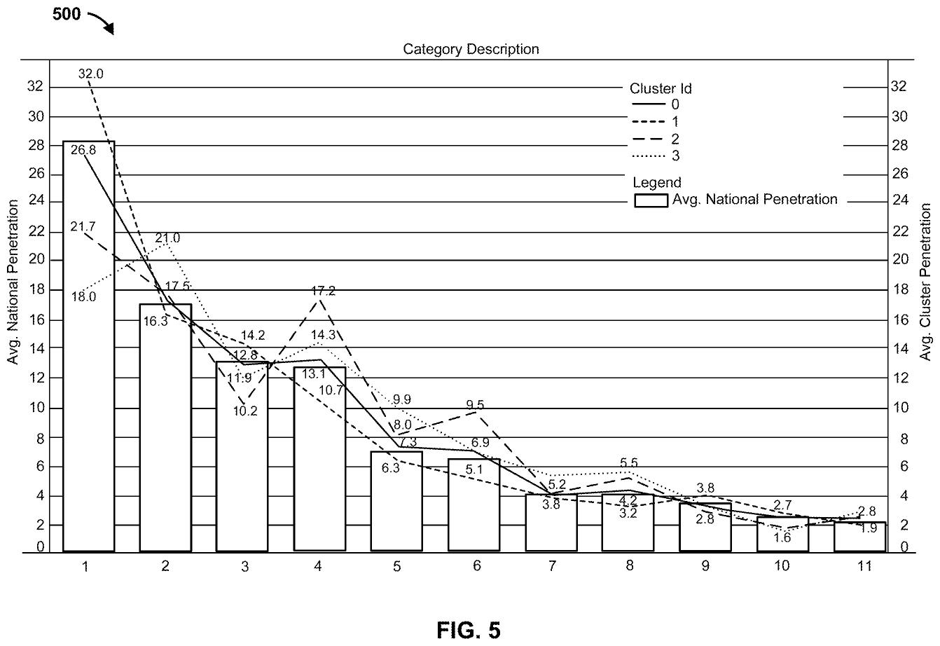

The store segmentation engine 302 improves on the divergence shown in FIG. 4. The use of a non-Euclidean distance metric is an improvement over traditional or existing methods by increasing the divergence between the store clusters or store segments. The non-Euclidean distance metric and the methods described herein are better able, through the use of machine learning, to identify distributions of stores that diverge from other distribution of stores. Referring now to FIG. 5, another graph 500 is shown that is similar to the graph of FIG. 4 but the store clusters shown in FIG. 5 were determining using an example store segmentation engine 302 of the present disclosure. The store segmentation engine 302 used a non-Euclidean distance metric to determine the store clusters 0, 1, 2 and 3 shown. As can be seen, the divergence between the store penetration for each sub-category of goods is greater than that shown in FIG. 4.

The store segmentation engine 302 can include, for example, a segmentation model that can use machine learning or other tools. The segmentation model can be trained, for example, using historical or other sales data of products or categories of products. The segmentation model can be trained in an unsupervised setting to determine features that, in turn, can be used to determine a divergence between stores or groups of stores. The store segmentation engine 302 can, for example, include a Gaussian Mixture Model (GMM) to determine the store segments. The GMM operates using machine learning to determine groups of stores (i.e., store segments) that have different distributions from other groups of stores.

In one implementation, the store segmentation engine 302 can obtain sales data that characterizes historical sales for products for each store. The store segmentation engine 302 can also obtain product category data that describes a taxonomy that is used by the retailer to organize its products into groups such as categories, sub-categories, departments, and the like. The product category data can describe which categories and sub-categories (or other groups) that each product is a part of. The sales data can be obtained, for example, from the sales server 104 and/or the database 110. The product category data can be obtained, for example, from the product information server 106 and/or from the database 110.

The store segmentation engine 302 can organize, transform or modify the sales data and the product category data into a suitable format for input into the segmentation model. In one example, the input data include a store identification number, a department number, a product category identification, and a unit sales number for one year. The segmentation model can use a Gaussian Mixture Model (GMM) to determine store segments for each store based on a non-Euclidean distance between store sales for like departments and/or like categories.

The segmentation model can output store segment identifiers that identify which stores represent similar stores for which each store segment diverges from other store segments by virtue of its sales of various products. Any suitable non-Euclidean distance metric can be used. In a preferred example, an Aitchison distance metric is used as the non-Euclidean distance metric. In other examples, a Mahalanobis Centered LogRatio (CLR) distance metric was used.

In the preferred example, the Aitchison distance metric was used and implemented using Equation 1 shown below.

$$d ( {x}_{i} , {x}_{j} ) = {( {\sum }_{k = 1}^{D} {( log ( \frac{{x}_{ik}}{g ( {x}_{i} )} ) - log ( \frac{{x}_{jk}}{g ( {x}_{j} )} ) )}^{2} )}^{\frac{1}{2}} \qquad Equation 1$$

where x=number of units sold in each category

Existing and traditional methods often employ Euclidean distances in determining a divergence or distance between data points. The non-Euclidean distance such as the Aitchison distance is an improvement over these traditional methods. The divergence of the segments determined by the store segmentation engine 302 can also be validated. Such validation can also be performed by the store segmentation engine 302 before the store segments are distributed or published to users. The store segments can be validated using any suitable metric. In one example, the store segments may be validated using a Jensen-Shannon divergence metric. The Jensen Shannon divergence metric can be applied to the store segments using Equation 2 below.

JSD(P∥Q)=½D(P∥M)+½D(Q∥M) Equation 2
where M=½(P+Q)
where P and Q represent the distribution of sales across different categories in two different clusters

One example segmentation model was trained and implemented to determine store segments for a first product department. The segmentation model showed significant divergence improvement over existing or traditional methods. In the first test example, the segmentation model of the present disclosure was compared against a traditional K-means cluster process. The K-means cluster process was implemented as known to one of ordinary skill in the art. The Jensen-Shannon divergence score for the segmentation model of the present disclosure totaled a divergence of about 0.057 and the Jensen-Shannon divergence score for the K-means process totaled a divergence of about 0.041. In a second test example for a second product department, the Jensen-Shannon divergence score for the segmentation model of the present disclosure totaled a divergence of about 0.039 and the Jensen Shannon divergence score the K-means process totaled a divergence of about 0.027. As shown, the segmentation model of the present disclosure shows significant improved divergence over the traditional K-means process.

Referring back to FIG. 3, the store segmentation computing device 102 may also include the allocation engine 304. The store allocation engine 304 can determine store allocations for each store segment determined by the store segmentation engine 302. The store allocation engine 304 can, for example, determine a percentage of each department in a store that should be allocated for each category and/or sub-category of products in the department. The percentage that is dedicated to each category and/or sub-category can be determined using the sales data for the stores in the store segment. For example, an average amount of sales (or sales penetration %) can be used to allocate each category and/or each sub-category in the department. Since the sales for each store segment diverge from each other, the store allocations for each store segment are likely to differ from one another. This difference allows the retailer to take advantage of the differences in customer behavior, purchasing patterns and the like to improve sales, revenue profits and to improve customer satisfaction.

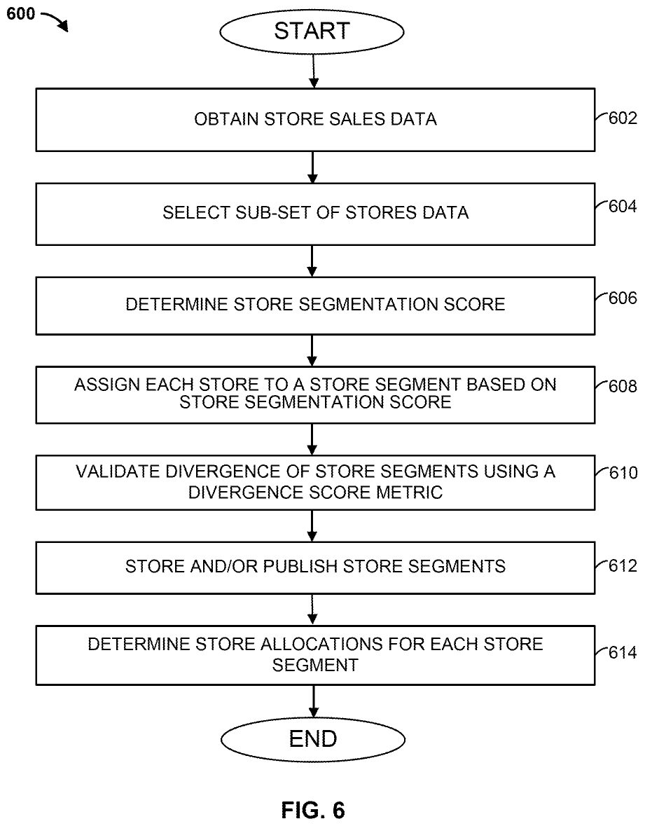

Referring now to FIG. 6, an example method 600 of determining store segments and store allocations is shown. The method 600 can be implemented and/or performed by the store space allocation systems of the present disclosure. The method 600 is described below with reference to the store space allocation systems 100 and 300. It should be appreciated, however, that other apparatuses and system may be used to implement one or more of the operations described.

The method 600 begins at step 602. At step 602, the store segmentation computing device 102 may obtain store sales data. The store sales data may characterize historical sales that have been made by various stores of a retailer. The store sales data can describe the products, store locations and amounts of sales that have been made. The store sales data can be obtained for any suitable length of time. In one example, sales data is obtained for the previous year's sales. The store segmentation computing device 102 can format or organize the data. The store segmentation computing device 102 may also obtain product category data that describes the taxonomy of the retailer's products. The store segmentation computing device 102 may organize the sales data based on the store and the department, category or other classification of products.

At step 604, the store segmentation computing device 102 may select a sub-set of the sales data. It has been uncovered during the development and testing of the store segmentation computing device that all of the sales data for all departments, categories, or sub-categories may be needed to effectively segment the store into divergent store segments. It has been determined that a sub-set of all sales data for each product department can be used to effectively segment to stores. The store segmentation computing device 102, therefore, may select a predetermined portion of the sales to use to segment the stores. In one example, a sub-set of the sales data that amounts to 90% of sales for the department of products can be used. In another example, a sub-set of the sales data amounts to 80% of sales for the department of products can be used. This predetermined number may translate to the top 10 sub-categories of each product category being used by the store segmentation computing device 102. The store segmentation computing device 102 may clip or discard the other data that is not used.

At step 606, the store segmentation computing device 102 may determine a store segmentation score. The store segmentation score may be determined, for example, by determining a non-Euclidean distance such as that previously described. The sales data and product category data can be used by the segmentation model or other suitable library or tool to determine the non-Euclidean distance. In some examples, the non-Euclidean distance is an Aitchison distance. In other examples, other non-Euclidean distances can be used.

At step 608, the store segmentation computing device 102 may assign each store to a store segment based on the store segmentation score. For example, the segmentation model may operate using a Gaussian Mixture Model to determine divergent distributions of stores using the non-Euclidean distance. Once the divergent distributions are identified by the model, each store that belongs to each divergent distribution can be assigned a store segment.

At step 610, the store segmentation computing device 102 may validate divergence of store segments using a divergence score metric. In one example, the divergence score metric is a Jensen-Shannon divergence metric. The divergence score metric can be determined using Equation 2 for example. The divergence score metric can be compared to the metric that is determined for a traditional or legacy system of the retailer. In other examples, the divergence score metric can be compared to a predetermined threshold. If the divergence score metric exceeds the predetermined threshold, the method can proceed. If the divergence score metric does not exceed the predetermined threshold, an alert can be sent and/or the method can return to the start of the method to repeat one or more steps of method 600.

At step 612, the store segmentation computing device 102 may store and/or publish the store segments. The store segments can be stored, for example, in database 110. The store segments can be stored in memory based on one or more data fields such as date, department, product, user ID or the like so that the store segments can be quickly and efficiently accessed. The store segments may also be published. In various examples, the store segmentation computing device 102 may send a message with the store segments. In other examples, the store segmentation computing device 102 may display the store segments via a graphical user interface, dashboard or other tool. In still other examples, other methods of publishing the store segments can be performed.

At step 614, the store segmentation computing device 102 may determine store allocations for each store segment. The allocation engine 304, as previously described, may determine the store space allocations. The store space allocations may describe a layout or other descriptions of portions of each store that are to be dedicated to the various categories or sub-categories of products. The store space allocations may be different for each store segment because of the different purchasing patterns and/or customer behaviors related to each store segment that drives the divergence of sales between the store segments.

Although the methods described above are with reference to the illustrated flowcharts, it will be appreciated that many other ways of performing the acts associated with the methods can be used. For example, the order of some operations may be changed, and some of the operations described may be optional.

In addition, the methods and systems described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The term model as used in the present disclosure includes data models created using machine learning and/or artificial intelligence. Machine learning may involve training a mathematical model in a supervised or unsupervised setting. Machine learning models may be trained to learn relationships between various groups of data. The models may be based on a set of algorithms that are designed to model abstractions in data by using a number of processing layers. The processing layers may be made up of non-linear transformations. Machine learning models may include, for example, neural networks, convolutional neural networks and deep neural networks. Such neural networks may be made of up of levels of trainable filters, transformations, projections, hashing, and pooling. The models may be used in large-scale relationship-recognition tasks. The models can be created by using various open-source and proprietary machine learning tools and/or libraries known to those of ordinary skill in the art.

The foregoing is provided for purposes of illustrating, explaining, and describing embodiments of these disclosures. Modifications and adaptations to these embodiments will be apparent to those skilled in the art and may be made without departing from the scope or spirit of these disclosures.

What is claimed is:

1. A system comprising:
at least one computing device configured to:
obtain store sales data for each store in a group of stores;
determine a store segmentation score using a non-Euclidean distance metric characterizing a distance between a pair of stores in the group of stores;
assign each store to a store segment based on the store segmentation score; and
validate a divergence of each pair of store segments using a divergence score metric.

2. The system of claim 1, wherein the store sales data comprises historical sales data for a plurality of categories of products, and the store segmentation score is determined using a sub-set of categories from the plurality of categories of products, the sub-set of categories comprising sales of products in categories for a predetermined percentage of overall sales of all products in the plurality of categories.

3. The system of claim 1, wherein each store is assigned to a store segment using a machine learning model.

4. The system of claim 3, wherein the machine learning model comprises a Gaussian Mixture Model (GMM).

5. The system of claim 1, wherein the non-Euclidean distance metric comprises an Aitchison distance metric.

6. The system of claim 1, wherein the divergence score metric comprises a Jensen-Shannon divergence metric.

7. The system of claim 1, wherein the computing device is further configured to determine store space allocations for each store segment.

8. A method comprising:
obtaining store sales data for each store in a group of stores;
determining a store segmentation score using a non-Euclidean distance metric characterizing a distance between pairs of stores in the group of stores;
assigning each store to a store segment based on the store segmentation score; and
validating a divergence of each pair of store segments using a divergence score metric.

9. The method of claim 8, wherein the store sales data comprises historical sales data for a plurality of categories of products, and the store segmentation score is determined using a sub-set of categories from the plurality of categories of products, the sub-set of categories comprising sales of products in categories for a predetermined percentage of overall sales of all products in the plurality of categories.

10. The method of claim 8, wherein each store is assigned to a store segment using a machine learning model.

11. The method of claim 10, wherein the machine learning model comprises a Gaussian Mixture Model (GMM).

12. The method of claim 8, wherein the non-Euclidean distance metric comprises an Aitchison distance metric.

13. The method of claim 8, wherein the divergence score metric comprises a Jensen-Shannon divergence metric.

14. The method of claim 8, further comprising determining store space allocations for each store segment.

15. A non-transitory computer readable medium having instructions stored thereon, wherein the instructions, when executed by at least one processor, cause a device to perform operations comprising:
obtaining store sales data for each store in a group of stores;
determining a store segmentation score using a non-Euclidean distance metric characterizing a distance between a pair of stores in the group of stores;
assigning each store to a store segment based on the store segmentation score; and
validating a divergence between each pair of store segments using a divergence score metric.

16. The non-transitory computer readable medium of claim 15, wherein the store sales data comprises historical sales data for a plurality of categories of products, and the store segmentation score is determined using a sub-set of categories from the plurality of categories of products, the sub-set of categories comprising sales of products in categories for a predetermined percentage of overall sales of all products in the plurality of categories.

17. The non-transitory computer readable medium of claim 15, wherein each store is assigned to a store segment using a machine learning model.

18. The non-transitory computer readable medium of claim 17, wherein the machine learning model comprises a Gaussian Mixture Model (GMM).

19. The non-transitory computer readable medium of claim 15, wherein the non-Euclidean distance metric comprises an Aitchison distance metric and the divergence score metric comprises a Jensen-Shannon divergence metric.

20. The non-transitory computer readable medium of claim 15, wherein the computing device is further configured to determine store space allocations for each store segment.
